(19) United States
(12) Patent Application Publication
(10) Pub. No.: US 2016/0029681 A1
(43) Pub. Date: Feb. 4, 2016

(54) METHOD OF ENHANCING BIOAVAILABILITY OF DHA AND OTHER LIPID-SOLUBLE NUTRIENTS

(71) Applicant: ABBOTT LABORATORIES, Abbott Park, IL (US)

(72) Inventors: Chron-Si Lai, Blacklick, OH (US); Randal Buddington, Memphis, TN (US); John Lasekan, Worthington, OH (US)

(73) Assignee: ABBOTT LABORATORIES, Abbott Park, IL (US)

(21) Appl. No.: 14/774,302

(22) PCT Filed: Mar. 12, 2014
(86) PCT No.: PCT/US14/24114

§ 371 Date: Sep. 10, 2015

Related U.S. Application Data
(60) Provisional application No. 61/779,006, filed on Mar. 13, 2013.

(51) Int. Cl. A23L 1/29; A23L 1/30

(52) U.S. Cl. CPC A23L 1/296; A23L 1/3008; A23V 2002/00

(57) ABSTRACT

A method of enhancing the bioavailability of a lipid-soluble nutrient, such as DHA, arachidonic acid, tocopherol, and carotenoids, in a newborn or preterm infant is disclosed. In this method, the lipid-soluble nutrient is administered in a nutritional product (such as an infant formula) to a preterm or newborn infant. The nutritional product comprises (a) an effective amount of the lipid-soluble nutrient; and (b) a fatty component comprising a combination of: (i) at least 6 g/l predigested fat, wherein the predigested fat includes at least one of: monoglycerides, free fatty acids, or a combination of monoglycerides and free fatty acids, and (ii) at least 1.44 g/l phospholipid. A method of enhancing cognition in newborn or preterm infants utilizing the nutritional product is also disclosed.

### CROSS REFERENCE TO RELATED APPLICATIONS

This application claims priority to and any benefit of U.S. Provisional Application No. 61/779,006, filed Mar. 13, 2013, the entire content of which is incorporated herein by reference.

### TECHNICAL FIELD

The present disclosure relates to nutritional products and the method of using those products to enhance the bioavailability of lipid-soluble nutrients, such as DHA.

### BACKGROUND

A wide variety of lipid soluble nutrients, such as docosahexaenoic acid (DHA), arachidonic acid (AA), Vitamin A, Vitamin E, Vitamin D, and Vitamin K, and carotenoids, such as lutein, lycopene, beta-carotene, beta-cryptoxanthin and zeaxanthin, are well-known in the art and provide important nutritional functions within the body. For example, DHA is a primary structural component of the human brain cerebral cortex, sperm, testicles, and retina. It is, in fact, the most abundant omega-3 fatty acid in the brain and retina. It modulates the carrier-mediated transport of choline, glycine and taurine, the function of delayed rectifier potassium channels, and the response of rhodopsin contained in the synaptic vesicles, among other functions. DHA deficiency is associated with cognitive decline. In addition, DHA is found at reduced levels in the brain tissue of severely depressed patients. There is a desire to enhance the bioavailability of such lipid-soluble nutritional materials so that they can be absorbed and advantageously used in the body. This is particularly important with infants, where even low levels of a nutrient can make a significant difference in terms of overall body health.

Breast milk fed infants have much higher serum lutein and alpha-tocopherol (Vitamin E) levels when compared with infants fed formula containing a similar lutein or alpha-tocopherol level. Breast milk contains lipase, and it has been shown that breast milk lipase is essential for newborn term infants to completely digest fat. Since lipid soluble nutrients have to be incorporated into the mixed micelles formed by digested fat, it is likely that the high bioavailability of the lipid soluble nutrients in breast milk is due to higher fat digestibility contributed by the breast milk lipase.

Medium chain triglyceride oil (MCT) is much easier to digest than long chain triglyceride oil. It, therefore, has been included in pre-term infant formula to improve fat digestion. While replacing long chain triglycerides with medium chain triglycerides improves fat digestion by as much as 10%, inclusion of MCT does not improve alpha-tocopherol bioavailability. Thus, the high bioavailability of the lipid soluble nutrient is unlikely to be due to higher breast milk fat digestion alone.

A goal of the present disclosure is to provide nutritional compositions, such as infant formula, which enhance the bioavailability of lipid-soluble nutrients.

### SUMMARY

The present disclosure relates to a method of enhancing the bioavailability of a lipid-soluble nutrient in newborn or preterm infants, by administering the lipid-soluble nutrient in a nutritional product comprising a fatty component selected from both at least about 6 grams/liter (“g/l”) predigested fat and at least about 1.44 g/l phospholipid.

In accordance with certain embodiments, a method of enhancing the bioavailability of a lipid-soluble nutrient in a newborn or preterm infant is disclosed. The method includes administering a nutritional product to the newborn or preterm infant. The nutritional product comprises (a) an effective amount of the lipid-soluble nutrient; and (b) a fatty component comprising a combination of: (i) at least 6 g/l predigested fat, wherein the predigested fat includes at least one of monoglycerides, free fatty acids, or a combination of monoglycerides and free fatty acids, and (ii) at least 1.44 g/l phospholipid.

The present disclosure also relates to a nutritional product for use in enhancing the bioavailability of a lipid-soluble nutrient in a newborn or preterm infant, the nutritional product comprising: (a) an effective amount of the lipid-soluble nutrient; and (b) a fatty component comprising a combination of: (i) at least 6 g/l predigested fat, wherein the predigested fat includes at least one of monoglycerides, free fatty acids, or a combination of monoglycerides and free fatty acids, and (ii) at least 1.44 g/l phospholipid.

In accordance with certain embodiments, the administration of the nutritional product to the newborn or preterm infant further results in enhanced cognition in the newborn or preterm infant.

### DETAILED DESCRIPTION

The terms “bioavailable” or “bioavailability” as used herein, unless otherwise specified, refer to the amount of a nutrient (e.g., lipid-soluble nutrient) made available to target tissues in a subject through the systemic circulation in the subject's body. In this context, the terms “bioavailable” or “bioavailability” may specifically refer to the ability of the nutrient to be absorbed from the gastrointestinal tract into lymph which will then enter into the bloodstream of an individual such that the substance can be absorbed into organs and tissues in the body. The bioavailability as used herein is determined according to the nutrient level in the serum of the individual. As the degree of bioavailability of a nutrient increases, the nutrient becomes more likely to enter into and remain in the bloodstream where it can be absorbed and used by the body. As the degree of bioavailability of a nutrient decreases, the nutrient becomes less likely to be absorbed into lymph from the gastrointestinal tract and instead is excreted from the body before entering the bloodstream.

The nutritional products encompassed by the present disclosure include infant formulas (for example, ready-to-consume liquids, reconstitutable concentrates, or reconstitutable powders), adult nutritional beverages or reconstitutable products, or nutritional supplements for adults or children, including those for pregnant women, as well as any other type of composition which can be consumed in order to provide a nutritional benefit. In a preferred embodiment, the nutritional product is an infant formula. These products are used in the method of enhancing the bioavailability of lipid-soluble nutrients, particularly in newborn or preterm infants. The nutritional products administered according to the methods disclosed herein include a lipid-soluble nutrient and a fatty component selected from predigested fat, phospholipid, or combinations of predigested fat and phospholipid.

The term “infant,” as used herein, refers to individuals not more than about one year of age, and includes infants from 0 to about 12 months of age, including “newborn infants” from 0 to about 3 months of age, including infants from 0 to 4 months of age, infants from about 4 months to about 8 months of age, infants from about 8 months to about 12 months, “low birth weight infants” at less than 2500 grams at birth, and “preterm infants” born at less than about 37 weeks gestational age, typically about 26 weeks to about 34 weeks gestational age.

The term “infant formula,” as used herein, refers to a nutritional product, which is formulated for infants to contain sufficient protein, carbohydrate, fat, vitamins, minerals, and other nutrients to serve as a potential sole or at least a partial source of nutrition when provided in sufficient quantity. Exemplary infant formulas are disclosed in Albrecht et al, U.S. Pat. No. 7,090,879, issued Aug. 15, 2006; Barrett-Reis et al, U.S. Pat. No. 7,829,126, issued Nov. 9, 2010; and Breitenbach et al, U.S. Provisional Application 61/393,206, published as PCT Published Patent Application WO 2012/049253, on Apr. 19, 2012, the disclosures of which are incorporated herein by reference.

Among the many nutritional formulas commercially available today, infant formulas have become particularly well-known and commonly used in providing a supplemental or sole source of nutrition early in life. Although human milk is generally accepted as a superior nutritional source for most, if not all, infants, many infant nutritional formulas can still provide a quality alternative for those mothers that cannot breast feed or choose not to under their particular circumstances. These infant formulas typically contain proteins, carbohydrates, lipids, vitamins, minerals and other nutrients and are frequently commercially available as reconstitutable powders, ready-to-feed liquids, and dilutable liquid concentrates.

Infant formulas are manufactured to be as close as possible to human breast milk in terms of nutritional quality. Fat is a major component and is among the key nutrients in human milk. The chemical and biochemical nature of human milk lipids have been studied extensively and infant formulas have been developed that have a fatty acid profile with many of the same chemical and biochemical properties as human breast milk. However, the physical structure of human milk lipids is also of nutritional significance for the infant and important for baby growth. The physical structure of milk fat has been shown to be important for lipase activity, cholesterol availability and lipid absorption in the gastrointestinal tract of neonates (Michalski et al., J. Dairy Sci. 88:1927-1940(2005)).

For the manufacturing of infant formula, vegetable fat mixes are added to target a fatty acid profile closer to that of breast milk, and an intermediate homogenizer is used in this process to form small fat droplets for better stability. Infant formulas, therefore, typically have a higher proportion of fat droplets below 1 micron compared to human breast milk. The infant formulas produced typically have good stability and a nutritional fatty acid profile close to that of human breast milk, but the fat particle size distribution is different from breast milk.

The term “ready-to-feed,” as used herein, unless otherwise specified, refers to nutritional products, including infant formulas, in liquid form suitable for administration to an infant, including reconstituted powders, diluted concentrates, and manufactured liquids.

Unless otherwise specified, all concentrations (e.g., those expressed as g/l, mg/l, or microgram/liter (“mcg/l ”)) refer to ingredient concentrations within the nutritional products disclosed herein as calculated on a ready-to-feed or as-fed basis.

Disclosed herein are nutritional products, such as infant formulas, comprising a lipid-soluble nutrient and a fatty component selected from predigested fat, phospholipid, or combinations of predigested fat and phospholipid. The term “predigested fat” as used herein refers to, monoglycerides, free fatty acids, or a combination of monoglycerides and free fatty acids.

The nutritional products may comprise fat, protein, carbohydrate, minerals, vitamins, and other nutrients and may be made by any known process for making nutritional products.

Lipid-soluble nutrients are well-known in the art. Examples of such materials include, but are not limited to, arachidonic acid (AA); eicosapaentanoic acid (EPA); docosahexaenoic acid (DHA); tocopherol in any isomer form; carotenoids such as lutein, lycopene, beta-carotene, beta-cryptoxanthin, and zeaxanthin; Vitamin A; Vitamin D; Vitamin E; and/or Vitamin K; as well as combinations of those materials. The materials not only provide nutritional benefits when ingested, but are lipid-soluble, i.e., they are soluble in fat-based materials. These materials are administered in a “nutritionally-effective amount,” i.e., an amount which is sufficiently large as to provide the desired nutritional benefit in a given patient population, but not so large as to result in significant side-effects to the patient, taking into consideration the patient's physical condition, age and size, among other characteristics.

It has been shown that most of the lipid-soluble nutrients, such as lutein and tocopherols, in circulation, are carried by lipoproteins. Breast milk fed infants are known to have a much higher serum cholesterol level than formula fed infants. Therefore, an effective way to boost lutein and alpha-tocopherol bioavailability is to boost infant serum lipoprotein levels. Applicant has shown that predigested fat increases serum lipoprotein levels, which indicates that predigested fat improves lutein bioavailability by 80%. Human pancreatic lipase digests triglycerides into free fatty acids and monoglycerides.

It has also been suggested that DHA in the form of phospholipids (also referred to as “PL-DHA”) is absorbed into brain tissue at a much faster rate than serum albumin bound DHA. DHA-containing phospholipids (from a pig brain) have been shown to be more functional than DHA fungal oil to mimic breast milk (in terms of PL-DHA level). Devlin et al, Lipids, 34(12):1313-1318 (1999), shows that supplementing infant formula with arachidonic acid (AA) and DHA from egg phospholipid alters bile metabolism by increasing the bile AA and DHA, as well as bile acid and phospholipid. However, phospholipid containing a high level of DHA is cost prohibitive for commercial use.

Most of the phospholipids in circulation are associated with lipoproteins. It is therefore believed that it is possible to boost the flow of DHA into an infant brain by increasing the number of lipoproteins. Applicant's research has shown that inclusion of phospholipids at no less that 4% of the fat system increases serum lipoprotein levels.

Lecithin is digested into lysolecithin and free fatty acid, then absorbed. Part of the lysolecithin is recombined with fatty acids to reform lecithin. It is believed that there is a possibility that the lysolecithin will be recombined with the DHA from DHA oil digestion to form PL-DHA in the mucosal cells if DHA concentration is not diluted by other fatty acids from regular long chain triglyceride (LCT) digestion. It is also believed that adding DHA oil to lecithin, then adding this mixture to the aqueous slurry, instead of the oil blend, in the preparation of an infant formula, would further enhance the PL-DHA formation.

As mentioned above, DHA (docosahexaenoic acid), which is an omega-3 fatty acid, is a primary structural component of the human brain cerebral cortex. It can be synthesized from alpha-linolenic acid or obtained directly from maternal milk or fish oil. DHA's structure is a carboxylic acid with a 22 carbon chain and 6 cis double bonds, the first double bond being located at the third carbon from the omega end of the molecule. DHA's trivial name is cervonic acid, its systematic name is all-cis-docosa-4,7,10,13,16,19-hexaenoic acid, and its shorthand name is 22:6 (n-3) in the nomenclature of fatty acids. Cold water oceanic fish oils are rich in DHA. DHA is the most abundant omega-3 fatty acid in the brain and retina. Further, it modulates the carrier-mediated transport of choline, glycine, and taurine. DHA deficiency is associated with cognitive decline (see Lukiw et al, J. Clin. Invest. 115 (10):2774-2783 (2005)). Conversely, increasing the amount of DHA in an infant via improved bioavailability according to the methods disclosed herein ultimately enhances cognition in the infant.

The lipid-soluble nutrient material in accordance with the methods of the present disclosure is administered in an “effective amount”, which is intended to define that level of material which provides the desired physiological benefit, but not so much as to provide undesired side effects to the user. For example, in an infant formula, an effective amount of DHA would be from about 50 mg/l to about 250 mg/l, including from about 60 mg/l to about 180 mg/l.

The method of the present disclosure also utilizes a fatty component for enhancing the bioavailability of the lipid-soluble nutrient. The fatty component is selected from a predigested fat, a phospholipid, or a combination of a predigested fat and a phospholipid.

Predigested fat includes monoglycerides, free fatty acids, and combinations of monoglycerides and free fatty acids. Examples of the free fatty acid predigested fat materials which can be utilized in accordance with the methods of the present disclosure include the following: free fatty acids or calcium-fatty acid salts (Ca-fatty acid salts) derived from an oil or blends of oils that contain a low level of saturated fatty acids with more than 14 carbons. In particular, preferred free fatty acid source oils include less than about 20% (by weight) saturated fatty acids. Examples of the monoglyceride predigested fat materials include monoglycerides that can be derived from various oils such as soy oil or coconut oil. Preferred monoglycerides include compounds selected from monoglyceryl palmitate, monoglyceryl oleate, monoglyceryl linoleate, and combinations thereof. When used, the predigested fat is present in the fatty component of the nutritional product in a level of at least about 6 g/l, such as at least about 7 g/l, at least about 14 g/l, or at least about 21 g/l. In accordance with certain embodiments, the fatty component of the nutritional product comprises from about 6 g/l to about 36 g/l predigested fat.

Other examples of predigested fat suitable for use in the methods according to the present disclosure include those disclosed in, for example, U.S. Published Patent Application 2012/0172443, Lai, published Jul. 5, 2012; U.S. Published Patent Application 2012/0172445, Lai et al., published Jul. 5, 2012; and U.S. Published Patent Application 2012/0172434, Lai et al., published Jul. 5, 2012; the disclosures of which are incorporated herein by reference.

The fatty component can also include a phospholipid, a lysophospholipid (partially digested phospholipids), and combinations of phospholipid and lysophospholipid. Phospholipids are a class of lipids that are a major component of all cell membranes since they can form lipid bilayers. Most phospholipids contain a diglyceride, a phosphate group, and a simple organic molecule such as choline; one exception to this rule is sphingomyelin, which is derived from sphingosine, instead of glycerol. The structure of the phospholipid molecule generally consists of a hydrophobic tail and a hydrophilic head. Examples of phospholipids include, for example, soy lecithin, egg phospholipid, phosphatidic acid, phosphatidylethanolamine, phosphatidylcholine (lecithin), phosphatidylserine, sphingomyelin, and lysolecithin. When included and used in the methods of the present disclosure, the fatty component of the nutritional product includes at least about 1.44 g/l phospholipid, including at least about 2.88 g/l phospholipid, and at least about about 4.32 g/l phospholipid. In accordance with certain embodiments, the fatty component of the nutritional product comprises from about 1.44 g/l to about 13 g/l of phospholipid.

In accordance with certain embodiments, nutritional products comprising a fatty component containing a combination of predigested fat and phospholipid are also used in the methods disclosed herein.

Preferred nutritional products disclosed herein additionally include at least about 100 mg/l cholesterol in the fatty component of the nutritional product to enhance the beneficial effect of the predigested fat and phospholipid. It has been reported that newborn formula fed infants have a negative cholesterol balance due to high level fecal excretion of bile components. Thus, formula fed infants will have to use the hepatically synthesized cholesterol to manufacture bile. Incorporation of cholesterol in the formula enhances the effect of predigested fat and phospholipids on serum lipoprotein, thus, further improving the bioavailability of lipid soluble nutrients. In accordance with certain embodiments, the fatty component comprises from about 100 mg/l to about 1,000 mg/l cholesterol.

The nutritional products disclosed herein may comprise fat, protein, carbohydrate, minerals and vitamins, all of which are selected in kind and amount to meet the dietary needs of the intended population. For example, an infant formula is made to meet the dietary needs of the intended infant population. Unless otherwise indicated herein, the term “fat” refers to the total fat in the nutritional product, including but not limited to, the fatty component, which as discussed above selected from a predigested fat, a phospholipid, or a combination of a predigested fat and a phospholipid, and which may further comprise cholesterol. In other words, the fatty component forms at least a portion of the fat of the nutritional product. In accordance with certain embodiments, the nutritional product further comprises carbohydrate, fat, and protein, wherein at least a portion of the fat is the fatty component. In accordance with certain of the preceding and other embodiments, the nutritional product further comprises from 54 g/l to 108 g/l carbohydrate, from 20 g/l to 54 g/l fat, and from 7 g/l to 24 g/l protein, wherein at least a portion of the 20 g/l to 54 g/l fat is the fatty component. In accordance with certain of the preceding and other embodiments, the nutritional product further comprises from 61 g/l to 88 g/l carbohydrate, from 27 g/l to 45 g/l fat, and from 10 g/l to 23 g/l protein, wherein at least a portion of the 27 g/l to 45 g/l fat is the fatty component.

Many different sources and types of carbohydrates, fats, proteins, minerals and vitamins are known and may be used in the infant formulas used in the present disclosure, provided that such nutrients are compatible with the added ingredients in the selected formulation and are otherwise suitable for use in an infant formula.

Carbohydrates suitable for inclusion in the infant formulas used in the methods of the present disclosure may be simple or complex, lactose-containing or lactose-free, or combinations thereof. Non-limiting examples of such carbohydrates include hydrolyzed, intact, naturally and/or chemically modified corn starch, maltodextrin, glucose polymers, sucrose, corn syrup, corn syrup solids, rice or potato-derived carbohydrates, glucose, fructose, lactose, high fructose corn syrup and indigestible oligosaccharides, such as fructooligosaccharides (FOS), galactooligosaccharides (GOS), and combinations thereof.

Proteins suitable for use in the infant formulas of the present composition include, for example, hydrolyzed, partially-hydrolyzed, and non-hydrolyzed or intact proteins or protein sources, and can be derived from any known or otherwise suitable source such as milk (e.g., casein, whey), animal (e.g., meat, fish), cereal (e.g., rice, corn), or combinations thereof.

Proteins may also include, or be entirely or partially replaced by, free amino acids known for or otherwise suitable for use in infant formulas, non-limiting examples of which include alanine, arginine, asparagine, carnitine, aspartic acid, cystine, glutamic acid, glutamine, glycine, histidine, isoleucine, leucine, lysine, methionine, phenylalanine, proline, serine, taurine, threonine, tryptophane, tyrosine, valine, and combinations thereof. These amino acids are most typically used in their L-forms, although the corresponding D-isomers may also be used when nutritionally equivalent. Racemic or isomeric mixtures may also be used.

Fats (in addition to the required fatty component containing predigested fat, phospholipid, or combination of predigested fat and phospholipid) suitable for use in infant formulas of the present disclosure may include, for example, coconut oil, soy oil, corn oil, olive oil, safflower oil, high oleic safflower oil, algae oil, MCT (medium chain triglyceride) oil, sunflower oil, high oleic sunflower oil, palm and palm kernel oils, palm olein, canola oil, marine oils, cotton seed oils, and combinations thereof.

Vitamins (in addition to those identified as lipid-soluble nutrients herein) and similar other ingredients that may be used in the infant formulas may include, for example, thiamine, riboflavin, pyridoxine, Vitamin B12, niacin, folic acid, pantothenic acid, biotin, Vitamin C, choline, inositol, salts and derivatives thereof, and combinations thereof.

Minerals suitable for use in the infant formulas described herein may include calcium, phosphorous, magnesium, iron, zinc, manganese, copper, chromium, iodine, sodium, potassium, chloride, and combinations thereof.

The infant formulas may comprise nutrients in accordance with the relevant infant formula guidelines for the targeted consumer or user population (an example of which would be the Infant Formula Act, 21 USC §350(a)).

The infant formulas described herein may also encompass those embodiments containing the carbohydrate, fat, and protein concentrations as described in the following table.

TABLE 1
Infant Formula Nutrients*

| Nutrient | Range | g/100 kcal | g/l** |
|---|---|---|---|
| Carbohydrate | 1^{st} embodiment | 8-16 | 54-108 |
| | 2^{nd} embodiment | 9-13 | 61-88 |
| Fat | 1^{st} embodiment | 3-8 | 20-54 |
| | 2^{nd} embodiment | 4-6.6 | 27-45 |
| Protein | 1^{st} embodiment | 1-3.5 | 7-24 |
| | 2^{nd} embodiment | 1.5-3.4 | 10-23 |

*All nutrient values may be modified by the term “about”
**From ready-to-feed liquid, reconstituted powder, or diluted concentrate

The infant formulas may include those embodiments that comprise per 100 kcal of formula of one or more of the following: Vitamin A (from about 250 to about 750 IU), Vitamin D (from about 40 to about 100 IU), Vitamin K (greater than about 4 mcg), Vitamin E (at least about 0.3 IU), vitamin C (at least about 8 mg), thiamine (at least about 8 g), Vitamin B12 (at least about 0.15 g), niacin (at least about 250 g), folic acid (at least about 4 g), pantothenic acid (at least about 300 g), biotin (at least about 1.5 g), choline (at least about 7 mg), and inositol (at least about 4 mg).

The infant formulas used in the present disclosure also include those embodiments that comprise, per 100 kcal of formula, one or more of the following: calcium (at least about 50 mg), phosphorous (at least about 25 mg), magnesium (at least about 6 mg), iron (at least about 0.15 mg), iodine (at least about 5 g), zinc (at least about 0.5 mg), copper (at least about 60 g), manganese (at least about 5 g), sodium (from about 20 to about 60 mg), potassium (from about 80 to about 200 mg), and chloride (from about 55 to about 150 mg).

The infant formulas may further comprise one or more optional ingredients that may modify the physical, chemical, aesthetic or processing characteristics of the compositions or serve as pharmaceutical or additional nutritional components when used in the targeted infant population. Many such optional ingredients are known or are otherwise suitable for use in nutritional products and may also be used in the infant formulas described herein, provided that such optional materials are compatible with the essential materials described herein and are otherwise suitable for use in an infant formula.

Non-limiting examples of such optional ingredients may include preservatives, antioxidants, emulsifying agents, buffers, colorants, flavors, nucleotides and nucleosides, probiotics, prebiotics, lactoferrin and related derivatives, thickening agents and stabilizers, and others well-known to those skilled in the art.

The infant formulas may have any caloric density suitable for the intended infant population, or provide such a density upon reconstitution of a powder embodiment or upon dilution of a liquid concentrate embodiment. Most common caloric densities for the infant formulas used in accordance with embodiments of the infant formulas disclosed herein are generally at least about 18 kcal/fl oz (about 609 kcal/l ), more typically from about 20 kcal/fl oz (about 676 kcal/l ) to about 25 kcal/fl oz (about 820 kcal/l ), even more typically from about 20 kcal/fl oz (about 676 kcal/l ) to about 24 kcal/fl oz (811 kcal/l ). Generally, 22 to 30 kcal/fl oz (about 744 to about 1014 kcal/l ), most typically from about 22 to 24 kcal/fl oz (about 744 to about 811 kcal/l ) formulas are used in preterm or low birth weight infants, and 20 to 21 kcal/fl oz (about 676 to about 700 kcal/l ) formulas are typically used in term infants. Higher caloric feedings may be used with preterm infants of low birth weight; such feedings are typically from about 27 kcal/fl oz (about 913 kcal/l ) to about 30 kcal/fl oz (about 1014 kcal/l ).

For powder embodiments, such powders are typically in the form of flowable or substantially flowable particulate compositions, or at least particulate compositions that may be easily scooped and measured with a spoon or similar device, wherein the compositions can easily be reconstituted by the intended user with a suitable aqueous fluid, typically water, to form a liquid nutritional formula for immediate oral or enteral use. In this context, “immediate” use generally means within about 48 hours, most typically within about 24 hours, preferably right after reconstitution. These powder embodiments may typically be made, for example, by an extrusion process or a spray drying process, although any known process for manufacturing a nutritional powder may be used. The quantity of a nutritional powder required to produce a volume suitable for one serving can vary.

The infant formulas may be packaged and sealed in a single or multi-use container, and then stored under ambient conditions for up to about 36 months or longer, more typically from about 12 to about 24 months. For multi-use containers, these packages can be opened and then covered for repeated use by the ultimate user, provided that the covered packages then stored under ambient conditions (e.g., avoiding extreme temperatures and moisture) and the contents used within about one month or so.

The infant formula products utilized in the methods of the present disclosure made by any method known in the art for making nutritional formulations, including extrusion or spray drying to form powder materials, or the mixing of wet components to form a concentrate or liquid formulation.

As discussed above, the present disclosure provides a method of enhancing the bioavailability of lipid-soluble nutrients by co-administering them with the fatty component materials described above. In one particular embodiment the method is applied to a newborn or preterm infant for the purpose of enhancing cognition in the infant.

All percentages, parts and ratios, as used herein, are “by weight” of the total composition, unless otherwise specified. All such weights as they pertain to listed ingredients are based on the active level and, therefore, do not include solvents or by-products that may be included in commercially available materials, unless otherwise specified.

All numerical ranges as used herein, whether or not expressly preceded by the term “about”, are intended and understood to be preceded by that term, unless otherwise specified.

Numerical ranges, as used herein, are intended to include every number and subset of numbers contained within that range, whether specifically disclosed or not. Further, these numerical ranges should be construed as providing support for a claim directed to any number or subset of numbers within that range. For example, a disclosure of “from 1 to 10” should be construed as supporting a range, for example, from 2 to 8, from 3 to 7, from 5 to 6, from 1 to 9, from 3.6 to 4.6, from 3.5 to 9.9, and so forth.

All references to singular characteristics or limitations of the present disclosure shall include the corresponding plural characteristic or limitation, and vice versa, unless otherwise specified or clearly implied to the contrary by the context in which the reference is made.

All documents (patents, patent applications and other publications) cited in this application are incorporated by reference herein in their entirety.

The nutritional products, including infant formulas, disclosed herein may also be substantially free of certain ingredients or features described herein, provided that the remaining product still contains all of the required ingredients or features as described herein. In this context, the term “substantially free” means that the selected product contains less than a functional amount of the optional or selected ingredient, typically less than about 0.1% by weight, and also including 0% by weight, of such optional or selected ingredient, based on the weight of the nutritional product.

The nutritional products, including infant formulas, and corresponding methods may comprise, consist of, or consist essentially of the essential elements, steps and limitations of the invention described herein, as well as any additional or optional ingredients, components, steps, or limitations described herein or otherwise useful in nutritional product applications.

### EXAMPLE

Table 2 below shows the bill of material used to manufacture 1,000 lbs (about 454 kg) of a powder which can be reconstituted into an infant formula and used in accordance with the method of the present disclosure. The nutritional products may be prepared by any known or otherwise effective manufacturing technique for preparing the selected product form. Many such techniques are known for any given product form, such as nutritional liquids and nutritional powders, and can easily be applied by one of ordinary skill in the nutrition and formulation arts to the nutritional products described herein.

Liquid, milk or soy-based nutritional liquids, for example, may be prepared by first forming an oil and fiber blend containing all formulation oils (fats), any emulsifier, fiber, lipid-soluble nutrients according to the methods disclosed herein, and other lipid-soluble (fat-soluble) vitamins. Additional slurries (typically a carbohydrate and two protein slurries) are prepared separately by mixing the carbohydrate and minerals together and the protein in water. The slurries are then mixed together with the oil blend. The resulting mixture is homogenized, heat processed, standardized with any water-soluble vitamins, flavored and the liquid terminally sterilized or aseptically filled or dried to produce a powder.

The nutritional products of the present disclosure may also be manufactured by other known or otherwise suitable techniques not specifically described herein without departing from the spirit and scope of the present disclosure. The present embodiments are, therefore, to be considered in all respects as illustrative and not restrictive and that all changes and equivalents also come within the description of the present disclosure.

TABLE 2

| Ingredients | Amount | |
|---|---|---|
| Coconut Oil | 61.98 | lb (28.11 kg) |
| High Oleic Safflower | 99.62 | lb (45.19 kg) |
| Cholesterol | 2.20 | lb (1.0 kg) |
| DHA Oil | 1.87 | lb (0.85 kg) |
| AA Oil | 3.75 | lb (1.70 kg) |
| Vitamin A, D, E, K Premix | 0.38 | lb (0.17 kg) |
| Palmitate Ascorbate | 0.36 | lb (0.16 kg) |
| Calcium Hydroxide | 5.98 | lb (2.71 kg) |
| Calcium Carbonate | 11.16 | lb (5.06 kg) |
| Whey Protein | 228.43 | lb (103.61 kg) |
| Non-Fat Dried Milk | 293.69 | lb (133.22 kg) |
| Galactose Oligosschrides Syrup | 69.50 | lb (31.52 kg) |
| Soy Fatty Acid | 71.16 | lb (32.28 kg) |
| Lutein | 0.01 | lb (0.0045 kg) |
| Mixed Tocopherols | 0.16 | lb (0.07 kg) |
| Monoglycerol Palmitate | 81.83 | lb (37.12 kg) |
| Monopotassium Phosphate | 0.55 | lb (0.25 kg) |
| Potassium Citrate | 4.46 | lb (2.02 kg) |
| Sodium Chloride | 0.88 | lb (0.40 kg) |
| Magnesium Chloride | 0.01 | lb (0.0045 kg) |
| Choline Chloride | 0.80 | lb (0.36 kg) |
| Potassium Iodide | 0.00046 | lb (0.0002 kg) |
| Lactose | 171.22 | lb (77.66 kg) |
| Lecithin | 35.58 | lb (16.14 kg) |
| Sodium Citrate | 2.14 | lb (0.97 kg) |
| Ferrous Sulfate | 0.46 | lb (0.21 kg) |
| L-Carnitine | 0.03 | lb (0.014 kg) |
| Nucleotide premix | 2.35 | lb (1.07 kg) |
| Water-Soluble Vitamin Premix 1370 | 1.12 | lb (0.51 kg) |
| Ascorbic Acid | 1.95 | lb (0.88 kg) |

TABLE 3

| | | | | | | Bio- | |
|---|---|---|---|---|---|---|---|
| | | | | | Lutein | Availability | Bioavailability |
| | | | | Serum | Daily | (Serum | Improvement |
| | Study | | | Lutein | Intake | Lutein:Lutein | Over Control |
| Infant | Period | Diet | Feeding/Day | (mcg/dl) | (mcg/kg/day) | Daily Intake) | (%) |
| 12002 | A | Control | 8 | 4.20 | 41.68 | 0.10 | 40 |
| | B | PDF | 7 | 5.10 | 35.78 | 0.14 | |
| 12003 | A | PDF | 9 | 4.50 | 42.87 | 0.10 | 11 |
| | B | Control | 9 | 5.00 | 56.24 | 0.09 | |
| 12004 | A | Control | 5 | 4.00 | 44.96 | 0.091 | |
| | B | PDF | 6.3 | 4.40 | 35.02 | 0.13 | 43 |
| 12005 | A | PDF | 6 | | | | |
| | B | Control | 5.3 | | | | |
| 12006 | A | Control | 6.3 | 3.50 | 38.05 | 0.09 | |
| | B | PDF | 6.3 | 3.70 | 32.44 | 0.11 | 22 |
| 12007 | A | Control | 6 | | | | |
| | B | PDF | 5.5 | | | | |
| 12009 | A | PDF | 5.8 | | | | |
| | B | Control | 5.5 | | | | |
| 12010 | A | Control | | 2.10 | | | |
| | B | PDF | | 3.60 | | | |
| 12012 | A | Control | 7.3 | 3.50 | 48.81 | 0.07 | |
| | B | PDF | 5.8 | 4.50 | 38.20 | 0.12 | 71 |
| 12013 | A | Control | 4.5 | 3.00 | 44.88 | 0.07 | |
| | B | PDF | 5 | 3.20 | 37.32 | 0.09 | 29 |
| 12014 | A | PDF | 5.4 | | | | |
| | B | Control | 5.3 | 4.50 | 41.98 | 0.11 | |
| 12016 | A | PDF | 10.3 | 6.30 | 28.68 | 0.22 | |
| | B | Control | 7.4 | 5.30 | 26.04 | 0.20 | 10 |
| 12018 | A | PDF | 5.3 | 4.80 | 29.68 | 0.16 | |
| | B | Control | 6.6 | 3.50 | 45.70 | 0.08 | 100 |

This is a randomized crossover study. Infants were fed either Control or a predigested fat (PDF) formula for 2 weeks. Following the 2 weeks, the infants were fed the other of the Control or PDF formula for 2 weeks. Notably, the PDF formula was prepared according to the formulation shown in Table 2 and contains monoglycerides (monoglycerol palmitate), free fatty acids (soy fatty acid), and phospholipds (lecithin). The Control formula is the same as the PDF formula except it does not contain the monoglycerides, free fatty acids, and phospholipds. Two blood samples were drawn at the end of the two week feeding period of each formula. The table above shows the infant serum lutein (mcg/dl), lutein daily intake (mcg/kg/day) and serum lutein to lutein intake ratio. The serum lutein to lutein intake ratio is an indicator for lutein bioavailability. Dietary lipid soluble nutrients such as lutein have to be absorbed, transported to liver, then packaged into lipoprotein to be bioavailable for organs like brain and eyes.

Table 3 shows an improvement ranging from 10% to 100% in the bioavailability of the lutein in the infants resulting from the PDF formula feeding as compared to the Control, as measured by the ratio of serum lutein to lutein daily intake, for those infants in which results were reported.

1-16. (canceled)

17. A method of enhancing the bioavailability of a lipid-soluble nutrient in a newborn or preterm infant, the nutritional product comprising:
(a) an effective amount of the lipid-soluble nutrient; and
(b) a fatty component comprising a combination of:
(i) at least 6 g/l predigested fat, wherein the predigested fat includes at least one of: monoglycerides, free fatty acids, or a combination of monoglycerides and free fatty acids, and
(ii) at least 1.44 g/l phospholipid.

18. The method according to claim 17, wherein the fatty component further comprises at least 100 mg/l cholesterol.

19. The method according to claim 17, wherein the lipid-soluble nutrient is selected from docosahexaenoic acid, arachidonic acid, eicosapaentanoic acid, Vitamin A, Vitamin D, Vitamin E, Vitamin K, a carotenoid, and combinations thereof.

20. The method according to claim 19, wherein the carotenoid is selected from lutein, lycopene, beta-carotene, zeaxanthin, beta-cryptoxanthin, and combinations thereof.

21. The method according to claim 17, wherein the fatty component comprises at least 14 g/l predigested fat.

22. The method according to claim 17, wherein the fatty component comprises no more than 36 g/l predigested fat.

23. The method according to claim 17, wherein the fatty component comprises at least 2.88 g/l phospholipid.

24. The method according to claim 17, wherein the fatty component comprises no more than 13 g/l phospholipid.

25. The method according to claim 17, wherein the nutritional product is an infant formula.

26. The method according to claim 17, wherein the nutritional product further comprises from 54 g/l to 108 g/l carbohydrate, from 20 g/l to 54 g/l fat, and from 7 g/l to 24 g/l protein, wherein at least a portion of the 20 g/l to 54 g/l fat is the fatty component.

27. The method according to claim 17, wherein the phospholipid is selected from soy lecithin, egg phospholipid, partially hydrolyzed lecithin, partially hydrolyzed egg lipid, and combinations thereof.

28. The method according to claim 17, wherein the lipid-soluble nutrient comprises from 50 mg/l to 250 mg/l DHA.

29. The method according to claim 17, wherein the predigested fat is a combination of unsaturated free fatty acids and monoglycerides.

30. The method according to claim 17, wherein the free fatty acids include less than 20% by weight saturated fatty acids.

31. The method according to claim 17, wherein the monoglycerides include a compound selected from monoglyceryl palmitate, monoglyceryl oleate, monoglyceryl linoleate, and combinations thereof.

32. The method according to claim 17, wherein use of the product further results in enhanced cognition in the newborn or preterm infant.

33. The method according to claim 18, wherein the nutritional product is an infant formula.

34. The method according to claim 26, wherein the nutritional product is an infant formula.

35. The method according to claim 17, wherein the nutritional product further comprises hydrolyzed protein.
